(19) United States
(12) Patent Application Publication
(10) Pub. No.: US 2001/0037239 A1
(43) Pub. Date: Nov. 1, 2001

(54) Method for a network-based revenue model utilizing a raffle contest

(76) Inventor: Satoshi Kanatani, Tokyo (JP)

Correspondence Address: OPPENHEIMER WOLFF & DONNELLP LLP, P.O. Box 52037, Palo Alto, CA, 94303-0746, US

(21) Appl. No.: 09/800,417

(22) Filed: Mar. 5, 2001

Related U.S. Application Data
(60) Provisional application No. 60/187,700, filed on Mar. 7, 2000.

(51) Int. Cl. G06F 17/60

(52) U.S. Cl. 705/14

(57) ABSTRACT

A method is provided for a network-based revenue model utilizing a raffle contest. Indicia is displayed on a computer terminal utilizing a network. An indication is received upon the selection of the indicia by a user at the computer terminal utilizing the network. Upon the receipt of the indication, a user is then prompted to enter of information relating to the user utilizing the network. When the information relating to the user is received, this information is then stored in a database. Subsequently, a raffle (or contest) function is executed utilizing the information stored in the database.

### CROSS REFERENCE TO RELATED APPLICATIONS

The present application is related to and claims benefit from co-pending provisional application “Method for a Network-Based Revenue Model Utilizing a Raffle Contest” by Inventor Satoshi Kanatani (Ser. No. 60/187,700, filed on Mar. 7, 2000, attorney docket # MAT1P001+) and incorporated herein by reference.

### FIELD OF THE INVENTION

This invention relates to electronic commerce (“e-Commerce), and more particularly to advertising and generating revenue utilizing a network such as the Internet.

### BACKGROUND

The Internet comprises a vast number of computers, network links between the computers, and protocol and other interface standards that provide a communication network for computer representatives to exchange computer data with other computer representatives. The World Wide Web (“WWW”) was designed as an easy visual interface for representatives of the Internet. The WWW allows a server computer, called a Web site, to send graphical Web pages of information, called Web pages, to a remote representative's computer and allows the remote representative's computer to display the Web pages on a display. These Web pages may contain control regions, such as simulated push buttons, that allow the representative to acquire and display additional, related Web pages of information in a hypertext fashion.

The Internet is based on information exchange from servers to clients. Each client and server has an Internet address called a Uniform Resource Locator (“URL”). An example of a URL address is “http://acme.com/page1.” The URL has two parts: (1) a scheme and (2) a scheme-specific part. The scheme identifies the high-level protocol through which the information is to be exchanged, and the scheme-specific part contains additional information useful in establishing a connection between a client and a server. The WWW uses the HTTP protocol. The “http” at the beginning of the example URL, above, is the scheme, and indicates that the Internet address specified by the example URL exchanges information using HTTP, and is therefore a WWW site. The remainder of the URL following the colon is the scheme-specific part that, for WWW servers, generally indicates a host HTTP server name and the file system path to a Web page to be transferred. In this example, the host HTTP server is identified by “acme.com” and the Web page is identified by “page1.”

Currently, a Web page is defined by a HyperText Markup Language (“HTML”) file. The software on a client that manages the Internet connections and interprets and effects the commands contained in HTML documents is called a browser. When a representative indicates to the browser a desire to view a Web page, the browser initiates a client computer request that the server transfer to the client computer an HTML file that defines the Web page. When the requested HTML file is received by the client computer, the browser uses the HTML file to construct the Web page and display it to the representative on the client computer display. The HTML file contains various commands for displaying text, graphics, controls, background colors for the Web page, and other displayed features. The HTML file may contain URL addresses of other Web pages available on the server, which allow the browser to offer to the representative hypertext-type selection and display of the other Web pages. In addition, the HTML file also may contain URL addresses, called hot links, to other Web pages at other Web sites. Thus, a representative may be able not only to navigate among Web pages available on the server to which he initially connected, but also among Web pages on entirely different servers. Additional types of Web page description facilities, other than HTML, are either currently available or planned for future release.

In general, the Web servers are stateless with respect to client transactions. In other words, at the HTTP protocol level, each transaction (e.g., request for an HTML file) is separate from all others. In other common networking system protocols, a client might initialize a connection to the server, conduct a series of requests from the server and receive information for each request, and then terminate the connection from the server, and the entire exchange, from the initialization to the termination of the connection, would be considered a transaction. In such systems, the client/server connection may be considered to be in one of several different states at any instance, depending on the nature of the requests and responses and their order. Such systems require that state information be saved by the server, and also usually by the client, and require time outs and other connection failure strategies. The stateless nature of the Web simplifies the server and client architectures.

The use and capabilities of the WWW have greatly increased in recent years. It is now a media that supports commerce and holds even greater promise for commerce in the future as a media that can connect buyers with sellers, can take actual orders, and can complete the associated payments.

However, the WWW today has several problems in supporting large scale commerce. For example, with such a large amount of information, it is often difficult to generate visits to one's website, or “hits”. Often revenue models are based on an amount of hits that are generated. Therefore, there is a need for further techniques of generating revenue by incurring visits to one's website.

### SUMMARY OF THE INVENTION

A method is provided for a network-based revenue model utilizing a raffle contest. Indicia is displayed on a computer terminal utilizing a network. An indication is received upon the selection of the indicia by a user at the computer terminal utilizing the network. Upon the receipt of the indication, a user is then prompted to enter of information relating to the user utilizing the network. When the information relating to the user is received, this information is then stored in a database. Subsequently, a raffle (or contest) function is executed utilizing the information stored in the database.

In an aspect of the present invention, the indicia may include a banner. In another aspect of the present invention, the indicia may include an icon on a banner. In a further aspect of the present invention, the indicia may be displayed in response to the selection of a banner displayed on a separate site on the network (i.e. portal, company website, etc). As another option, the banner and the indicia may all be located on a single portal or company website for allowing the exclusive control thereof. Further, the entry of information may be prompted on a separate page on the network separate from that on which the indicia is located.

In one embodiment of the present invention, the indicia may include a first indicia, (i.e. raffle indicia), and a second indicia (i.e. advertisement indicia), and the indication is received upon the selection of the raffle indicia. In such an embodiment, linking to a separate site on the network may occur upon the selection of the advertisement indicia. As an option for this embodiment, linking to the separate site on the network may also occur after receiving the information relating to the user. This separate site on the network may further be linked to upon the selection of a link indicia.

In even another embodiment of the present invention revenue may generated utilizing a network by displaying a first indicia and a second indicia on a computer terminal from a first site utilizing the network. In this embodiment, the first indicia and second indicia are displayed in response to the selection of a banner displayed on a second site on the network. Next, an indication is received upon the selection of either the first indicia or the second indicia by a user at the computer terminal utilizing the network. This leads to a prompting for the entry of information relating to the user at the first site upon the receipt of the indication that the first indicia is selected. When this information relating to the user is received, it is then stored in a database for executing a function. Upon receipt of the indication that the second indicia has been selected, linking to a third site associated with the second indicia occurs. In one aspect of this embodiment, the function may be a raffle function.

In another embodiment, an indicia is displayed separately from a banner on a computer terminal on a first site utilizing a network. The indicia can for example be an icon or graphical image. An indication is received upon selecting the indicia separate from the banner by the user. The user is then linked to a distributing computer which determines which client site to send the user to.

In yet another embodiment, an indicia is displayed separately from a banner on a computer terminal on a first site utilizing a network. The indicia can for example be an icon or graphical image. An indication is received upon selecting the indicia separate from the banner by the user. The user is then linked to a distributing server and is prompted for personal information. Based upon this information, the distributing server determines which set of impact/client site pairs the user will next be linked to. Once the user is done viewing the impact site, the corresponding client site is displayed.

In a final embodiment, an indicia is displayed separately from a banner on a computer terminal on a first site utilizing a network. The indicia can for example be an icon or graphical image. An indication is received upon selecting the indicia separate from the banner by the user. The user is then linked to a raffle server and is offered a chance to participate in a raffle. Once indication is received whether the user participated in or skipped the raffle, the user is then linked to a distributing server and is prompted for personal information. Based upon this information, the distributing server determines which set of impact/client site pairs the user will next be linked to. Once the user is done viewing the impact site, the corresponding client site is displayed.

### BRIEF DESCRIPTION OF THE DRAWINGS

The invention will be better understood when consideration is given to the following detailed description thereof. Such description makes reference to the annexed drawings wherein:

FIG. 1 is a schematic diagram of a system for generating revenue utilizing a network in accordance with an embodiment of the present invention;

FIG. 2 is a schematic diagram of a hardware implementation of one embodiment of the present invention;

FIG. 3 is a flowchart for a process for generating revenue utilizing a network in accordance with an embodiment of the present invention;

FIG. 4 is a schematic diagram illustrating a configuration of a system for generating revenue utilizing a network in accordance with an embodiment of the present invention;

FIG. 5 is a flowchart for a process for generating revenue utilizing a network with the configuration of the system illustrated in FIG. 4 in accordance with an embodiment of the present invention;

FIG. 6 is a schematic diagram illustrating another configuration of a system for generating revenue utilizing a network in accordance with an embodiment of the present invention;

FIG. 7 is a flowchart for a process that may be carried out by the configuration illustrated in FIG. 6 for generating revenue utilizing a network in accordance with an embodiment of the present invention;

FIG. 8 is a schematic diagram illustrating a further configuration of a system for generating revenue utilizing a network in accordance with an embodiment of the present invention;

FIG. 9 is a flowchart for a process that may be carried out by the configuration illustrated in FIG. 8 for generating revenue utilizing a network in accordance with an embodiment of the present invention;

FIG. 10 is a schematic illustration of a banner advertisement in accordance with an embodiment of the present invention.

FIG. 11 is a flowchart for a process for generating revenue utilizing a network in accordance with an embodiment of the present invention;

FIG. 12 is a schematic diagram illustrating a configuration of a system for generating revenue utilizing a network in accordance with an embodiment of the present invention;

FIG. 13 is a flowchart for a process for generating revenue utilizing a network in accordance with an embodiment of the present invention;

FIG. 14 is a schematic diagram illustrating a configuration of a system for generating revenue utilizing a network in accordance with an embodiment of the present invention;

FIG. 15 is a flowchart for a process for generating revenue utilizing a network in accordance with an embodiment of the present invention;

FIG. 16 is a schematic diagram illustrating a configuration of a system for generating revenue utilizing a network in accordance with an embodiment of the present invention;

### DETAILED DESCRIPTION OF THE PREFERRED EMBODIMENTS

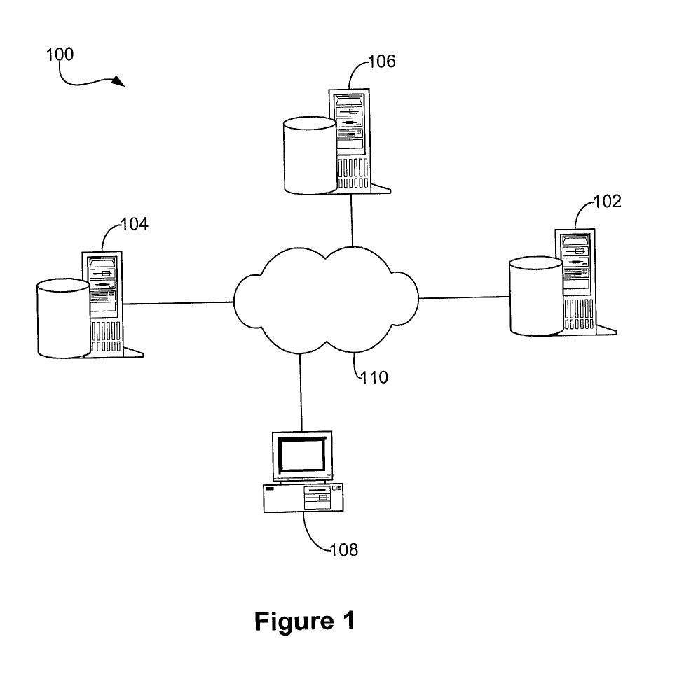

FIG. 1 is a schematic diagram of a system 100 of the present invention for generating revenue utilizing a network in accordance with an embodiment of the present invention. Specifically, this system 100 may comprise a plurality of computers 102, 104, 106, 108 connected to one another utilizing a network 110 such as, for example, the Internet. In further detail, the plurality of computers may include a first computer 102 coupled to the network 110 that may host a website that provides advertising and raffling functions, a second computer 104 coupled to the network 110 that may hosts a portal or gateway website that users may access utilizing the network, and a third computer 106 coupled to the network 110 that may host a third website. The portal website of the second computer 104 may also display advertising relating to the third website of the third computer 106 and may also include links for permitting users to access the third website from the second website utilizing the network. The plurality of computers of the system may also include a fourth computer 108 (such as for example, a personal computer) coupled to the network 110 which enables a user to access the network and thereby the websites hosted by the first, second and third computers.

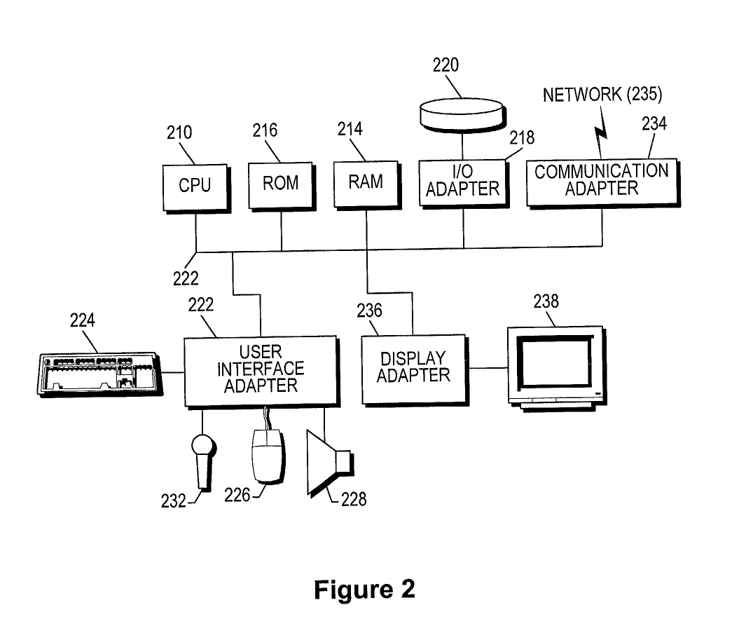

One embodiment of the system in accordance with the present invention may be practiced in the context of a personal computer such as an IBM compatible personal computer, Apple Macintosh computer or UNIX based workstation. A representative hardware environment is depicted in FIG. 2, which illustrates a typical hardware configuration of a workstation in accordance with a preferred embodiment having a central processing unit 210, such as a microprocessor, and a number of other units interconnected via a system bus 222. The workstation shown in FIG. 1 includes a Random Access Memory (RAM) 214, Read Only Memory (ROM) 216, an I/O adapter 218 for connecting peripheral devices such as disk storage units 220 to the bus 222, a user interface adapter 222 for connecting a keyboard 224, a mouse 226, a speaker 228, a microphone 232, and/or other user interface devices such as a touch screen (not shown) to the bus 222, communication adapter 234 for connecting the workstation to a communication network (e.g., a data processing network) and a display adapter 236 for connecting the bus 222 to a display device 238. The workstation typically has resident thereon an operating system such as the Microsoft Windows NT or Windows/95 Operating System (OS), the IBM OS/2 operating system, the MAC OS, or UNIX operating system. Those skilled in the art will appreciate that the present invention may also be implemented on platforms and operating systems other than those mentioned.

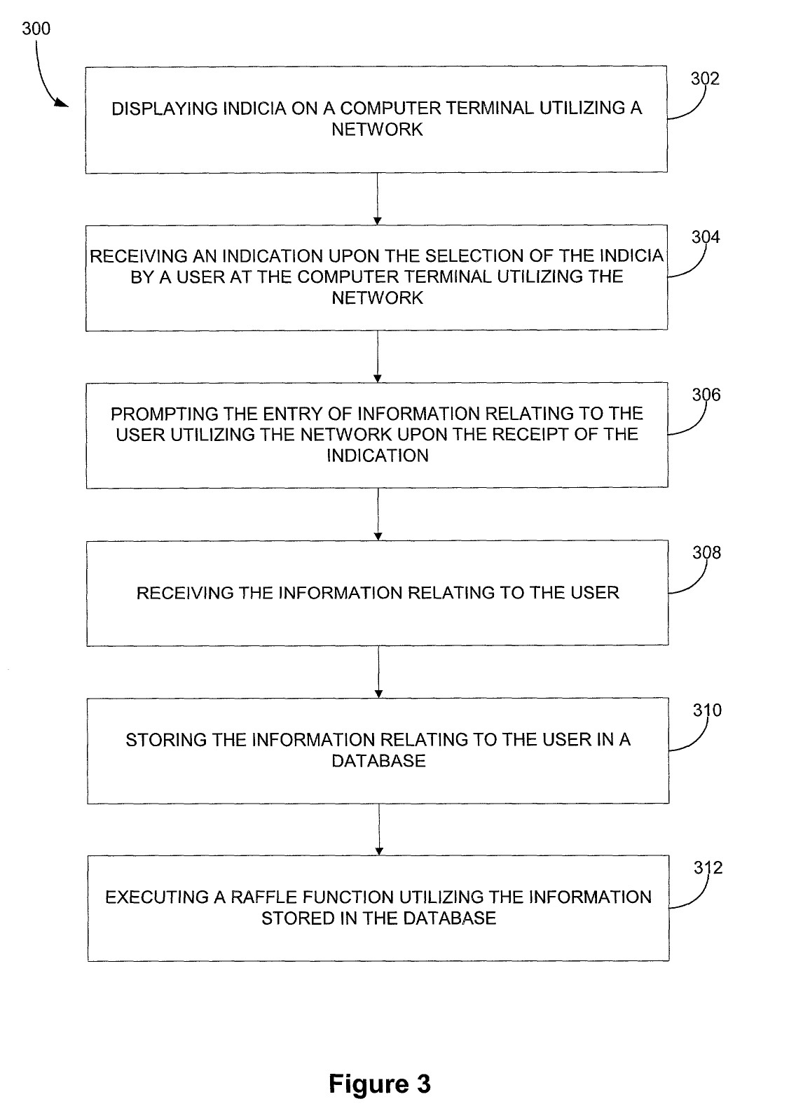

FIG. 3 is a flowchart for a process 300 for generating revenue utilizing a network where indicia is displayed on a computer terminal utilizing a network in operation 302. In operation 304, an indication is received upon the selection of the indicia by a user at the computer terminal utilizing the network. Upon the receipt of the indication, a user is then prompted to enter of information relating to the user utilizing the network in operation 306. When the information relating to the user is received in operation 308, this information is then stored in a database in operation 310. Subsequently, a raffle function is executed in operation 3112 utilizing the information stored in the database in operation.

In an aspect of the present invention, the indicia may include a banner. In another aspect of the present invention, the indicia may include an icon on a banner. In a further aspect of the present invention, the indicia may be displayed in response to the selection of a banner displayed on a separate site on the network. In yet an additional aspect of the present invention, the entry of information may be prompted on a page on the network separate from that on which the indicia is located. In a further aspect of the present invention, the indicia may be displayed in response to the selection of a banner displayed from a site on the network from which the indicia is displayed.

In one embodiment of the present invention, the indicia may include a first indicia and a second indicia and the indication is received upon the selection of the first indicia. In such an embodiment, linking to a separate site on the network may occur upon the selection of the second indicia. As one option in such an embodiment, the second indicia may be advertisement indicia. In yet another option for this embodiment, linking to the separate site on the network may also occur after receiving the information relating to the user. This separate site on the network may further be linked to upon the selection of a link indicia.

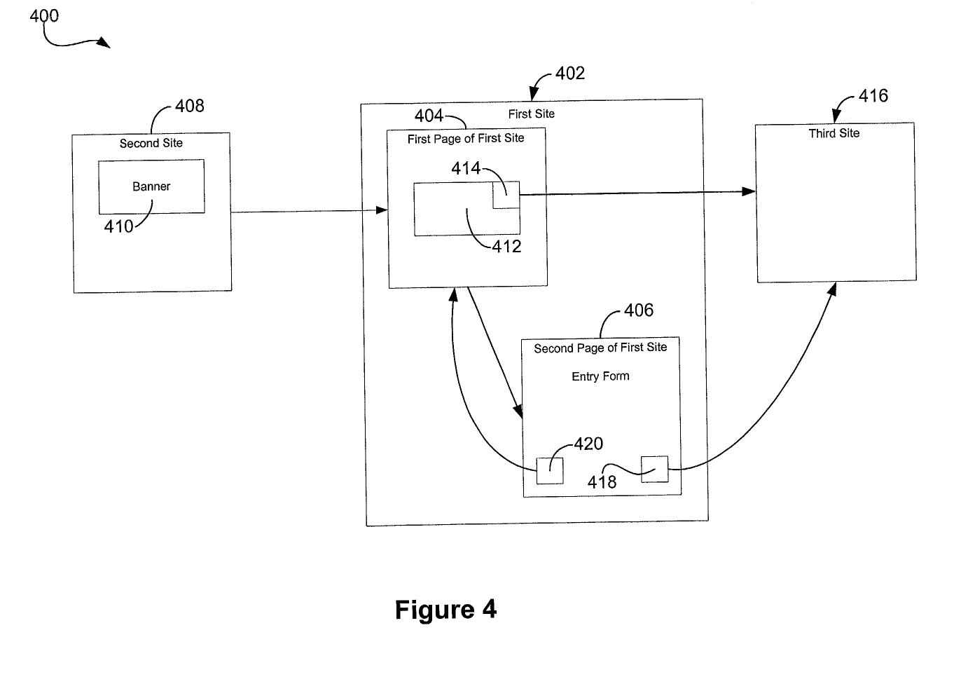

FIG. 4 is a schematic diagram illustrating a first configuration 400 of the present invention for generating revenue utilizing a network in accordance with an embodiment of the present invention. In this configuration 400, the first computer 102 hosts a first web site 402 on the network that has a first and second web pages 404, 406. The second computer 102 hosts a second web site 408 on the network that displays a selectable banner 410. When the banner 410 is selected, the first web page 404 of the first web site 402 is then displayed with selectable first and second advertisement indicia 412, 414 displayed thereon. In one aspect of the present invention, the second advertisement indicia 414 may be an icon located inside the boundary of the first advertisement indicia 412. Optionally, the second advertisement indicia 414 may located adjacent an end or corner region of the first advertisement indicia 412.

In an aspect of the present invention, the first advertisement indicia 412 may comprise a banner advertisement or an e-mail magazine that may, in an illustrative embodiment advertise a third web site 4162. In another aspect of the present invention the second advertisement indicia 414 may comprise an icon or some sort of graphic image.

In an additional aspect of the present invention, the first advertisement indicia 412 may further include information advertising a raffle and an invitation for the user to enter the raffle by selecting the first advertisement indicia 412. A raffle may be defined as a lottery in which the prize is won by one of numerous persons that have entered the lottery. The first advertisement indicia 412 may also be linked to the second web page 406 of the first web site 402 so that second web page 406 is displayed when the first advertisement indicia 412 is selected. The second web page 406 may comprise an entry form that includes one or more fields into which a user at the fourth computer 108 may input (when prompted) information including personal information relating to the user. This information may then be transmitted to the first computer 106 and stored in a database of the first computer 106 so that it may be used by the first computer when performing functions to execute a raffle with the user as an entrant in the raffle.

The second advertisement indicia 414 may be linked to the third web site 416 which may be hosted by the third computer 106 so that the third web site is displayed upon selection by the user of the second advertisement indicia 414. In one aspect of the present invention, the third web site 416 may include information relating to the advertising information displayed on the first web page of the first web site including the advertising information displayed on the first advertisement indicia 412.

Thus, in an illustrative example, the banner 410 may comprise information advertising the third website, which for illustrative purposes may be a web site for a company selling Honda automobiles. Continuing with this illustrative example, the first advertisement indicia 412 may comprise information inviting a user to enter a raffle or drawing or contest for some sort of prize. In this illustrative example, the second advertisement indicia 414 may comprise information that indicates to the user that if the user wishes not to enter or skip entry into the raffle, then the user should select the second advertisement indicia 414 to access the third web site 416 (e.g., the web site of the company selling Honda automobiles).

The second web page 406 of the first web site 402 may also display a first link indicia 418 which is adapted for linking to the third web site 416 when selected by a user. This way, the user may access the third web site 416 from the second web page 406. As an option, the second web page 406 may also display a second link indicia 420 which is adapted for linking to the first page 404 of the first web site 402 when selected by a user. This way, the user may return to the first web page 404 from the second web page 406.

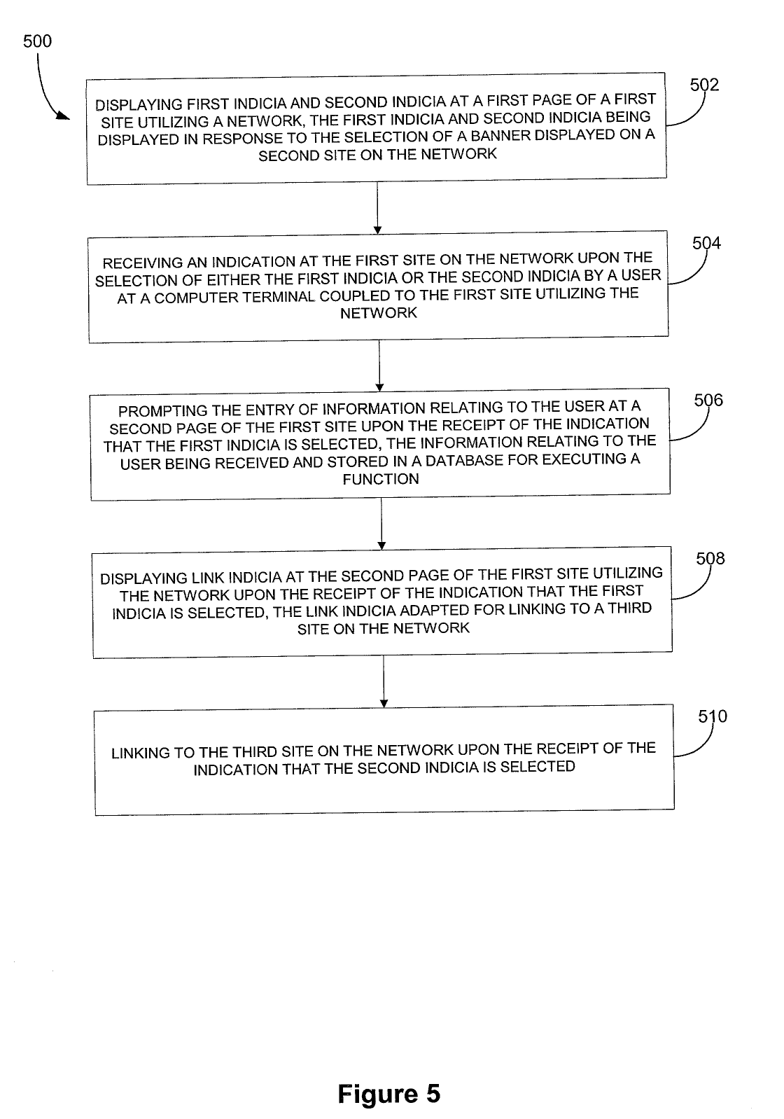

FIG. 5 is a flowchart for a process 500 for generating revenue utilizing a network with the first configuration 400 in accordance with an embodiment of the present invention In operation 502, first and second advertisement indicia are displayed at a first page of a first site utilizing a network. The first and second advertisement indicia are displayed in response to the selection of a banner displayed on a second site on the network. In operation 504, an indication is received at the first site on the network upon the selection of either the first or second advertisement indicia by a user at a computer terminal coupled to the first site utilizing the network. In operation 506, a user is prompted for the entry of information relating to the user at a second page of the first site upon the receipt of the indication that the first advertisement indicia is selected. This information relating to the user is subsequently received and stored in a database for executing a function. In operation 508, link indicia is displayed at the second page of the first site utilizing the network upon the receipt of the indication that the first advertisement indicia is selected. This link indicia is adapted for linking to a third separate site on the network associated with the first site upon the selection thereof by the user. In operation 510, linking to the third site on the network occurs upon the receipt of the indication that the second advertisement indicia is selected. In one aspect of this configuration, the first advertisement indicia may include raffle indicia and the function is may be a raffle function.

It should be noted, that in an optional embodiment of the present invention, it may be provided that selection either the first or second advertisement indicia by the user jumps the user to the third site (which may be, for example, the home page of a company advertised or expressed in the banner or email magazine) without going to the site that manages the raffle, drawing, or contest.

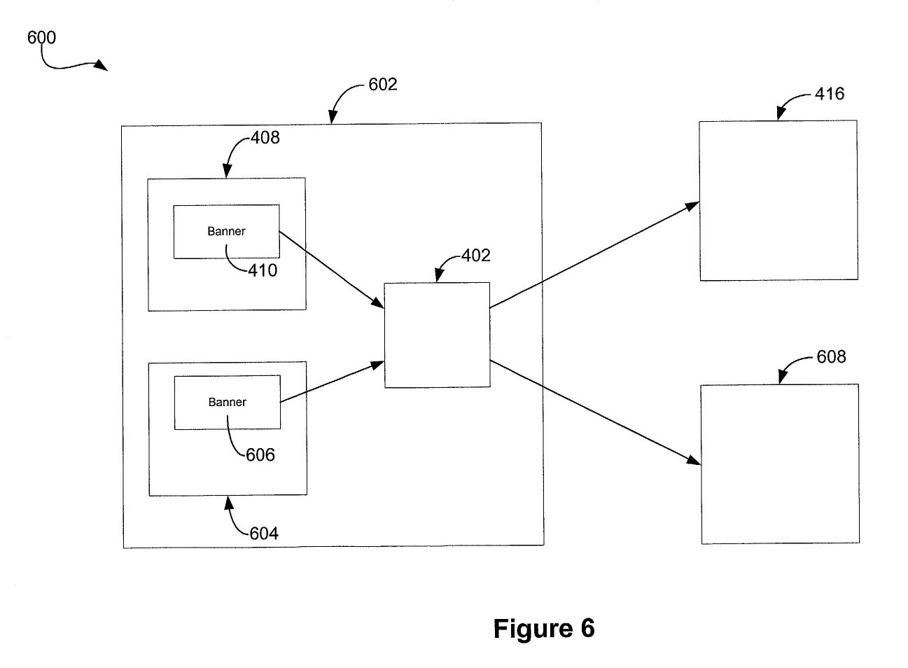

FIG. 6 is a schematic diagram illustrating a second configuration 600 of the present invention for generating revenue utilizing a network in accordance with an embodiment of the present invention. In this configuration, the first and second pages of the first web site 402 and second web site 408 are located in a common site 602. Thus, in this configuration, the first page 404 of the first site comprises the first page of the common site 602, the second site 408 comprises the second page of the common site and the second page 406 of the first site comprises a third page of the common site 602. In this second configuration 600, the third site 416 is linked and associated with the first site 402 in a similar manner as in the first configuration 400.

As an option, the common site may also include one or more additional pages 604 similar to the second site 408 (i.e., the now second page of the common site). As such, the additional pages 604 all may include a banner 606 (like banner 410) which is linked to the first page 404 of the first site 402 (now the first page of the common site) so that selection of this banner 606 displays the first site 402 to the user. In such an option, a fourth site 608 may be associated with the additional page 604 in a similar manner as the second site is associated with the third site 416. For example, selecting the banner 606 in the additional page 604 will link the user to an entry form for a contest associated with the fourth site and also link the user to the fourth site in a manner similar to that described involving the first configuration 400.

Thus, in general, the difference between this second configuration 600 of the present invention and the first configuration 400 is that the locations of the first and second sites 402, 408 are located on a common computer or server in the second configuration while the first and second sites 402, 408 are located on separate computers or servers in the first configuration. For example and with reference to FIG. 1, in the first configuration, the first site 402 may be hosted by the first computer 102 while the second site 408 may be hosted by the second computer 104. As a further illustration of this example, the first site 402 may be hosted by the computer (e.g., the first computer 102) that manages the raffle or contest while the second site 408 may be hosted by the computer (e.g., the second computer 104) that manages an Internet portal.

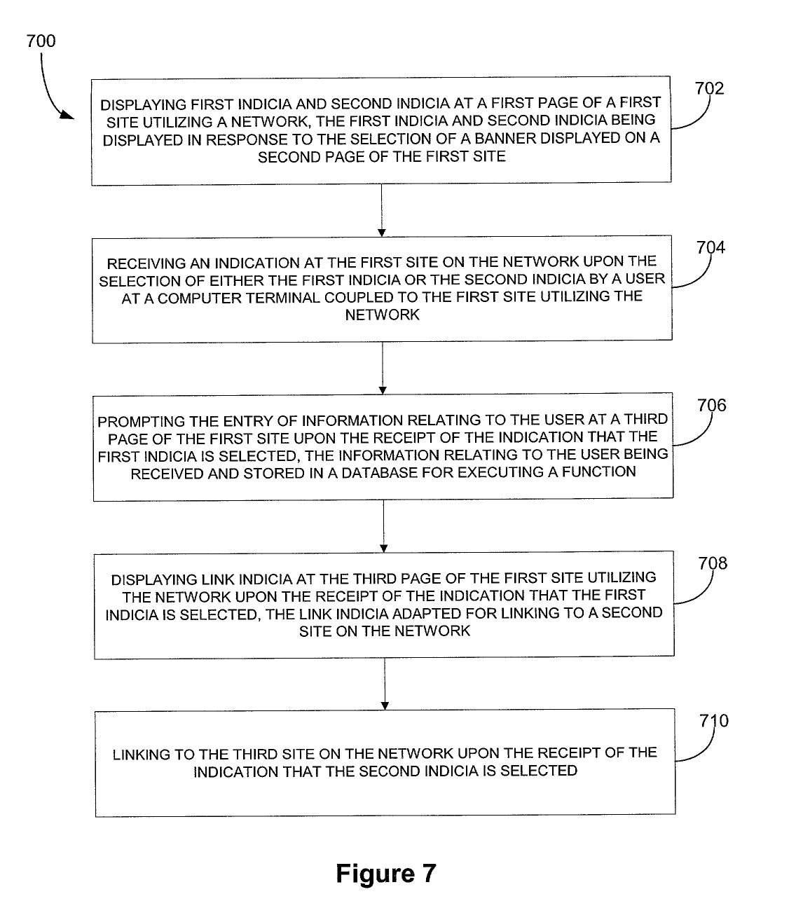

FIG. 7 is a flowchart for a process 700 carried out by the second configuration 600 of the present invention for generating revenue utilizing a network in accordance with an embodiment of the present invention. In operation 702, first advertisement indicia and second advertisement indicia are displayed at a first page of a first site utilizing a network. The first advertisement indicia and second advertisement indicia are displayed in response to the selection of a banner displayed on a second preceding page of the first site. An indication is received in operation 704 at the first site on the network upon the selection of either the first advertisement indicia or the second advertisement indicia by a user at a computer terminal coupled to the first site utilizing the network. Upon the receipt of the indication that the first advertisement indicia is selected, the user is then prompted for entering information relating to the user at a third page of the first site in operation 706. Once received, this information relating to the user then stored in a database for executing a function. In operation 708, link indicia is displayed at the third page of the first site utilizing the network upon the receipt of the indication that the first advertisement indicia is selected, the link indicia adapted for linking to a second separate site on the network associated with the banner on the second page of the first site upon the selection thereof by the user. Linking to the third site on the network occurs in operation 710 upon the receipt of the indication that the second advertisement indicia is selected. In one aspect of this configuration, the first advertisement indicia may include raffle indicia, and the function may be a raffle function.

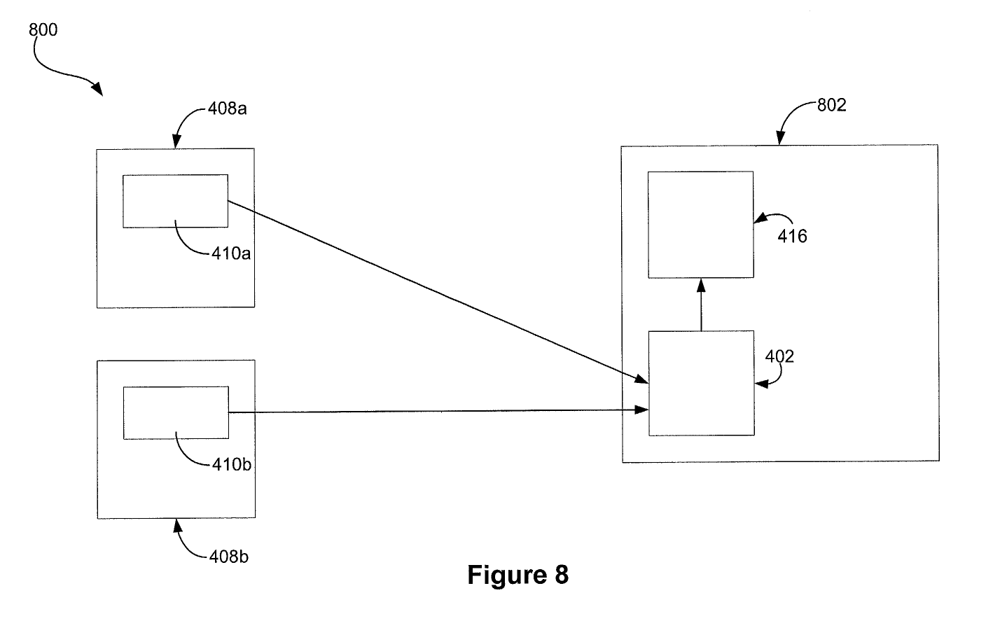

FIG. 8 is a schematic diagram illustrating a third configuration 800 of the present invention for generating revenue utilizing a network in accordance with an embodiment of the present invention. In general, this third configuration 800 of the present invention is distinguishable from the first and second configurations 400, 600 in that first and third sites 402, 416 are located on a common computer 802 or server with one or more (preferably separate) second sites 408a, 408b linked to the common site 802 (in a similar functional manner to those of the first and second configurations 400, 600). In contrast, the first, second and third sites 402, 408, 416 are located on separate computers or servers in the first configuration 400. In contrast to the second configuration 600 of the present invention, the first and second sites 402, 408 of the third configuration are not located on a common computer or server as is the case in the second configuration. As an example of the third configuration and with reference to FIG. 1, the first and third sites 402, 416 may be hosted by the third computer 106 while the second site 408 may be hosted by the second computer 104. As a further illustration of this example, the first and third sites 402, 416 may be hosted by the computer (e.g., the third computer 106) managed by a company that sells Honda automobiles while the second site 408 may be hosted by the computer (e.g., the second computer 104) that manages an Internet portal.

In closer detail, the second sites 408a, 408b of the third configuration may be similar to the second sites 408 of the first and second configurations 400, 600, in that each of the second sites 408a, 408b may display a selectable banner 410a, 410b which function like the banners 410 of the first and second configuration. For example, when either banner 408a, 408b is selected, the first page 404 of the first site 402 is then displayed with selectable first and second advertisement indicia 412, 414 displayed thereon.

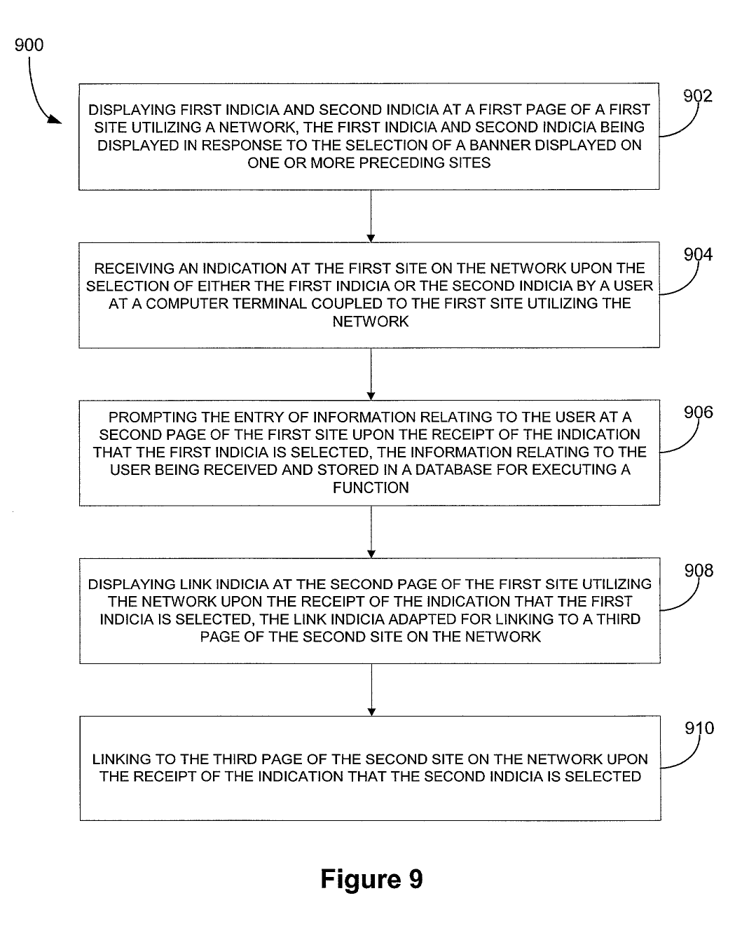

FIG. 9 is a flowchart for a process 900 carried out by the third configuration 800 of the present invention for generating revenue utilizing a network. In response to the selection of a banner displayed on one or more preceding sites, first and second first advertisement indicia are displayed at a first page of a first site utilizing a network in operation 902. In one aspect of this configuration, the first advertisement indicia may include raffle indicia. Next, upon the selection by a user of either the first or second advertisement indicia, an indication is received at the first site on the network in operation 904. In this configuration, the user is located at a computer terminal coupled to the first site utilizing the network. In operation 906, after receipt of an indication indicating that the first advertisement indicia has been selected by the user, the user is then prompted to enter information relating to the user at a second page of the first site. This information relating to the user is then received and stored in a database for executing a function, such as a raffling function. Link indicia is also displayed at the second page of the first site utilizing the network in operation 908 upon the receipt of the indication that the first advertisement indicia has been selected. This link indicia is adapted, upon selection thereof, for linking to a third page of the second site on the network associated with the banner on the preceding sites. In operation 910, linking to the third page of the second site on the network upon the receipt of the indication that the second advertisement indicia is selected.

In even another embodiment of the present invention revenue may generated utilizing a network by displaying a first indicia and a second indicia on a computer terminal from a first site utilizing the network. In this embodiment, the first indicia and second indicia are displayed in response to the selection of a banner displayed on a second site on the network. Next, an indication is received upon the selection of either the first indicia or the second indicia by a user at the computer terminal utilizing the network. This leads to a prompting for the entry of information relating to the user at the first site upon the receipt of the indication that the first indicia is selected. When this information relating to the user is received, it is then stored in a database for executing a function. Upon receipt of the indication that the second indicia has been selected, linking to a third site associated with the second indicia occurs. In one aspect of this embodiment, the function may be a raffle function.

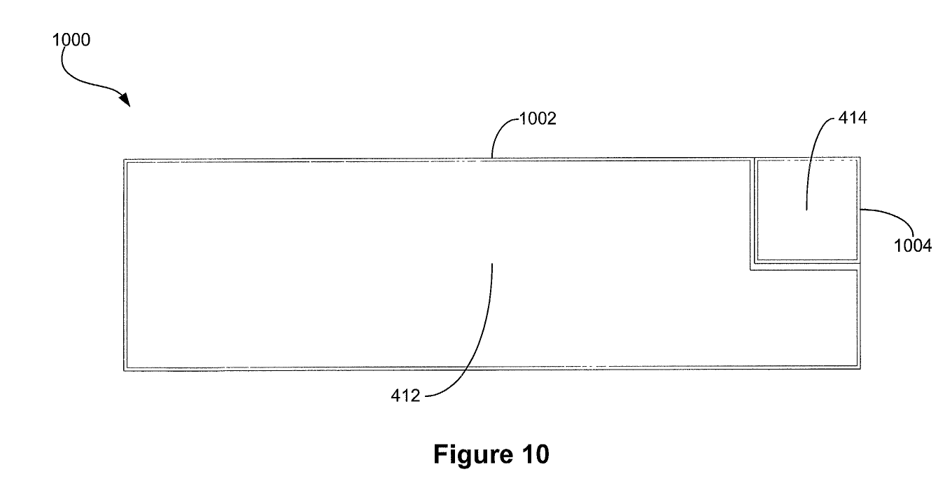

FIG. 10 is a schematic illustration of a banner advertisement 1000 that may be displayed by the first page 404 of the first site 402 in any of the configurations 400, 600, 800 in accordance with an embodiment of the present invention. With reference to FIG. 10, the banner 1000 may be one or more graphic advertising images. As discussed earlier, the banner advertisement 1000 may include the selectable first and second advertisement indicia 412, 414. In one embodiment of the present invention, the second advertisement indicia 414 may be located adjacent a corner of the first advertisement indicia 412 as illustrated in FIG. 10.

As an option, the banner 1000 may actual comprise two adjacent banners with one of the banners having a boundary 1002 around the first advertisement indicia 412, and the other banner having a boundary 1004 around the second advertisement indicia 414 (the dashed lines illustrated in FIG. 10 which extend adjacent to the boundaries have been added in order to provide further visual indication of the two boundaries and need not be included in the actual banners). In such an embodiment, the proximity of the two adjacent banners provides a visual illusion of a single banner 1000.

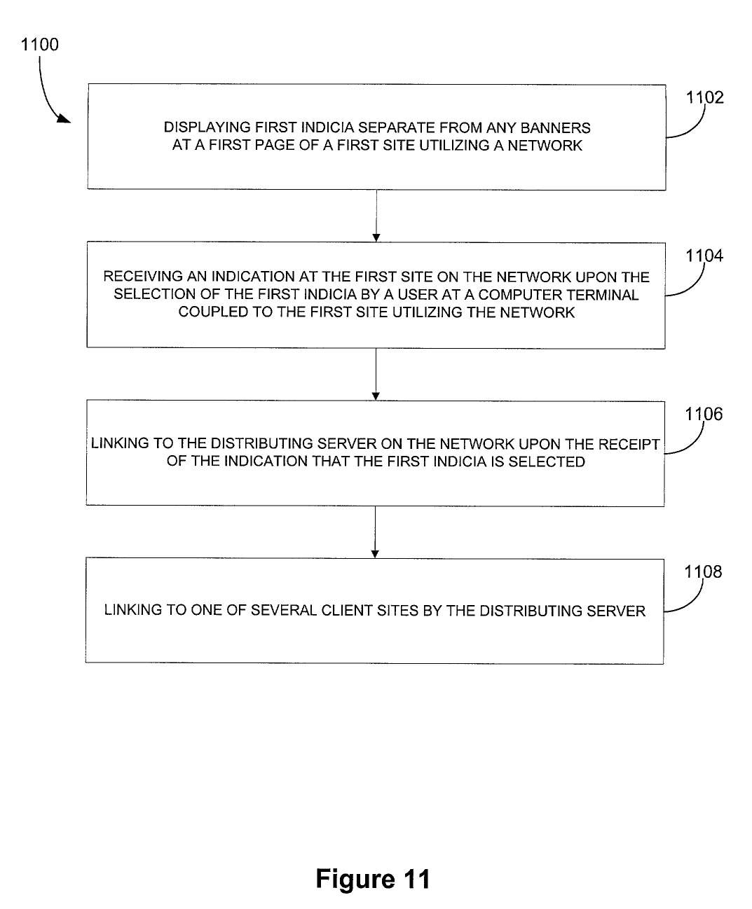

FIG. 11 is a flowchart for a process 1100 of directing network traffic by way of a distribution server where indicia is displayed separate from any banners on a computer terminal utilizing a network in operation 1102. In operation 1104, an indication is received upon the selection of the indicia separate from any banners by a user at the computer utilizing the network. Upon receipt of the indication, the user is linked to a distributing server in operation 1106. The user is then linked to one of several client sites by the distributing server in operation 1108.

In an aspect of the present invention, the indicia may include an icon separate from any banners. In another aspect of the present invention, the distributing server determines what client site to direct the user to based upon predefined information such as user information.

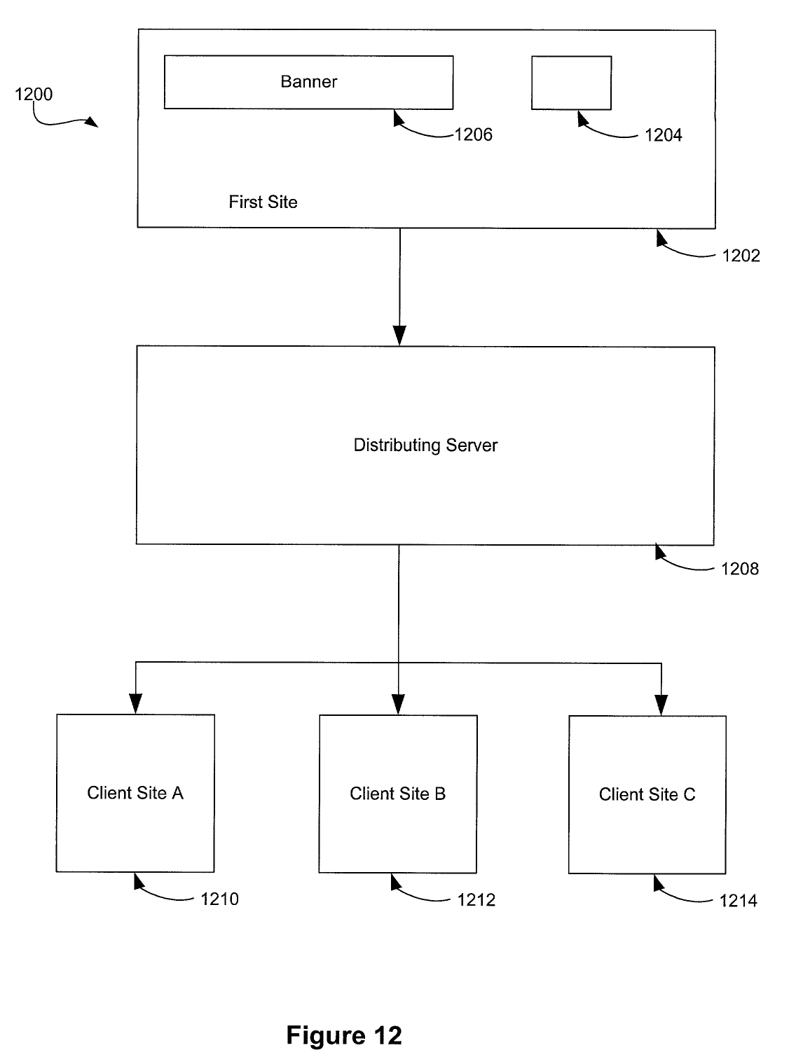

FIG. 12 is a schematic diagram illustrating a fourth configuration 1200 of the present invention for generating revenue utilizing a network in accordance with an embodiment of the present invention. In this configuration 1200, a first site 1202 contains an icon 1204, separate from a banner 1206. When the icon 1204 is selected, the user is directed to the distributing server 1208, at which point it is determined to which client site the user is directed to—client site A 1210, client site B 1212 or client site C 1214. It will be appreciated by one skilled in the art that the distributing server can direct network traffic to any number of client sites and the above example is not meant to limit the scope of the present invention.

In an aspect of the present invention, the icon 1204 may comprise an image or advertisement to induce the user to click on it. In another aspect of the present invention, the distributing server 1208 determines which client site (1210, 1212 or 1214) to use based on the network load. For example, if there are 12 users accessing the distributing server 1208 via the icon 1204 then 4 users are sent to client site A 1210, 4 are sent to client site B 1212 and the balance are sent to client site C 1214. In a further aspect of the present invention, the user can be rewarded points that can be used to redeem awards and gifts based upon the number of times they select the icon 1204.

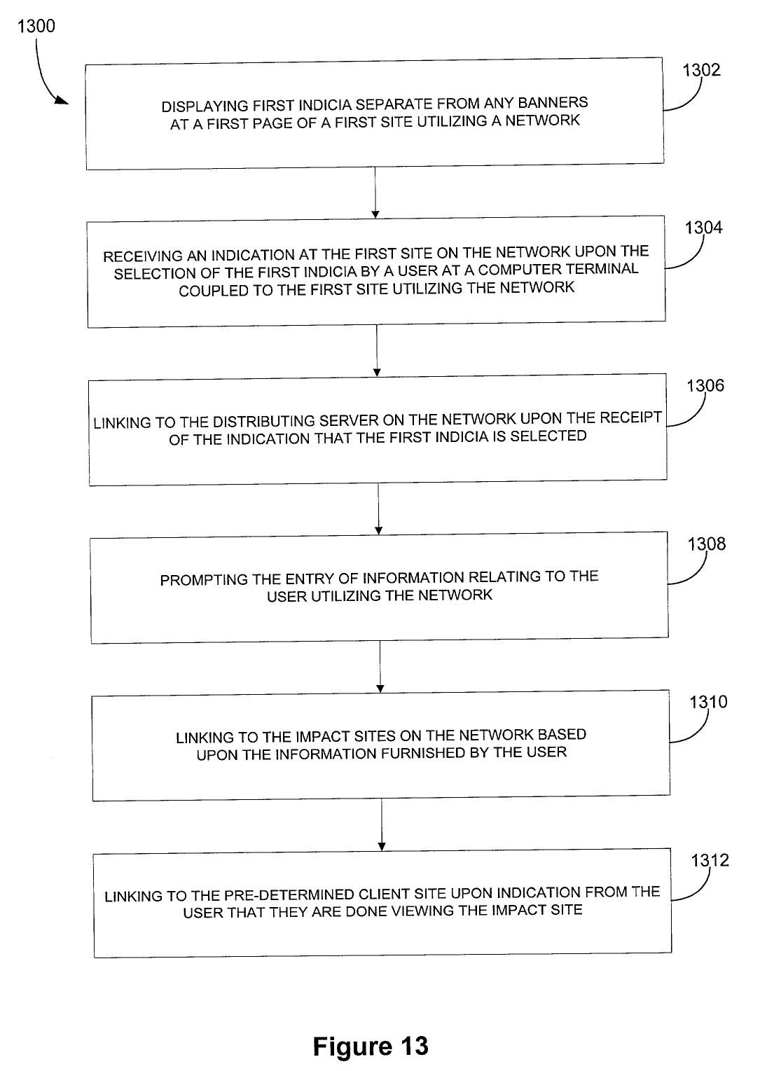

FIG. 13 is a flowchart for a process 1300 of directing network traffic by way of a distribution server where indicia is displayed separate from any banners on a computer terminal utilizing a network in operation 1302. In operation 1304, an indication is received upon the selection of the indicia separate from any banners by a user at the computer utilizing the network. Upon receipt of the indication, the user is linked to a distributing server in operation 1306. The user is then prompted for entry of information relating to the user in operation 1308. In operation 1310, the user is linked to an impact site based upon the information supplied in the previous operation. The user is then linked to the pre-determined client site upon indication from the user that they are done viewing the impact site in operation 1312.

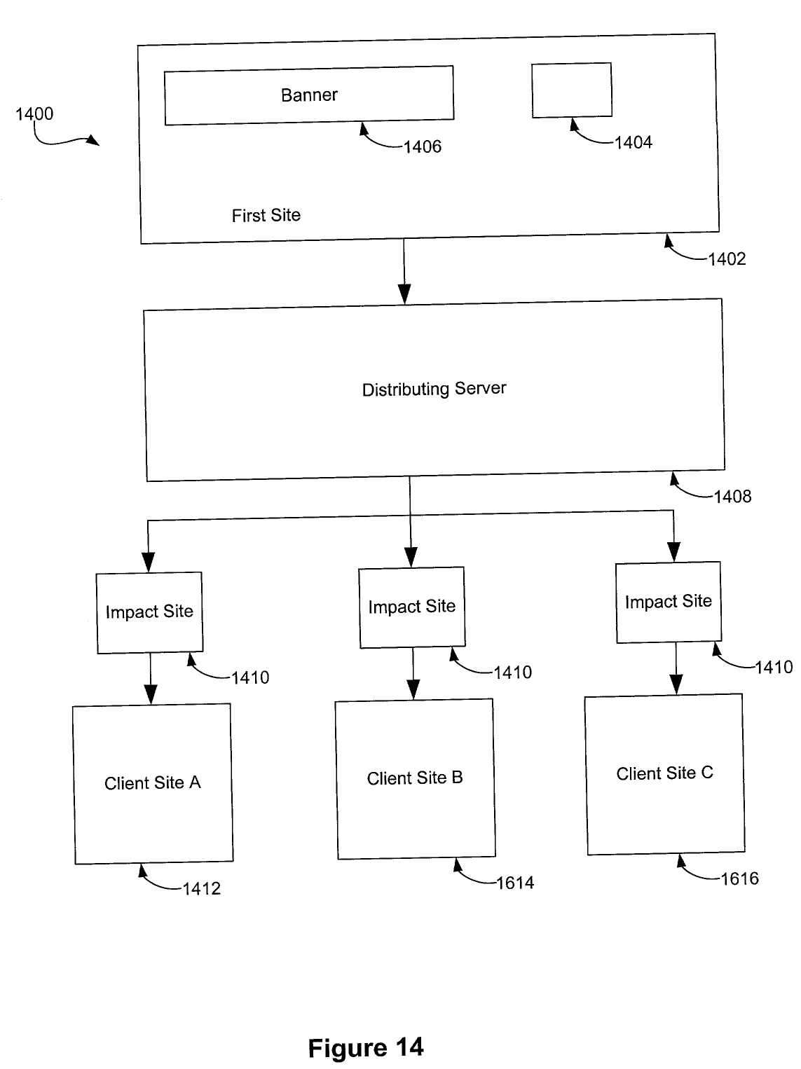

FIG. 14 is a schematic diagram illustrating a fifth configuration 1400 of the present invention for generating revenue utilizing a network in accordance with an embodiment of the present invention. In this configuration 1400, a first site 1402 contains an icon 1404, separate from a banner 1406. When the icon 1404 is selected, the user is directed to the distributing server 1408. The user is then prompted for information pertaining to the user. This information determines which of the impact pages 1410 to direct the user to. After the user is done viewing one of the impact pages 1410 which they were directed to, they are then linked to the corresponding client site—client site A 1410, client site B 1412 or client site C 1414. It will be appreciated by one skilled in the art that the distributing server can direct network traffic to any number of impact/client site combinations and the above example is not meant to limit the scope of the present invention.

In an aspect of the present invention, the information entered by the user into the distributing server 1408 can include gender, age and occupation. Clients can predefine what types of users they want to access their site. For example, client site A 1410 may only want male businessmen in their twenties while client site B 1412 prefers female housekeepers 30 to 39 years of age. In another aspect of the present invention, the impact pages 1410 are small in size and therefore do not contain large amounts of data as fully sized web pages. As a result, they load very quickly on a user's computer and the user won't mind taking the time to view the information contained therein.

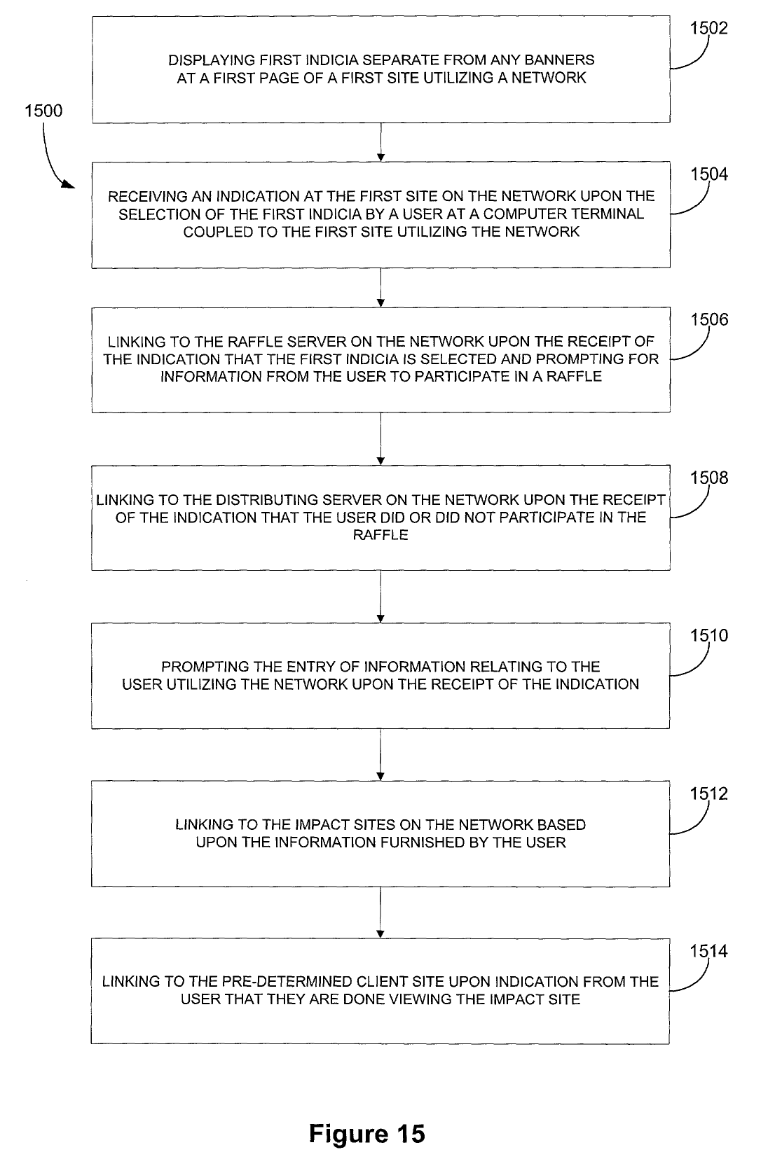

FIG. 15 is a flowchart for a process 1500 of directing network traffic by way of a distribution server where indicia is displayed separate from any banners on a computer terminal utilizing a network in operation 1502. In operation 1504, an indication is received upon the selection of the indicia separate from any banners by a user at the computer utilizing the network. Upon receipt of the indication, the user is linked to a raffle server and offered the chance to participate in a raffle. The user is then linked to a distributing server in operation 1508. The user is then prompted for entry of information relating to the user in operation 1510. In operation 1512, the user is linked to an impact site based upon the information supplied in the previous operation. The user is then linked to the pre-determined client site upon indication from the user that they are done viewing the impact site in operation 1514.

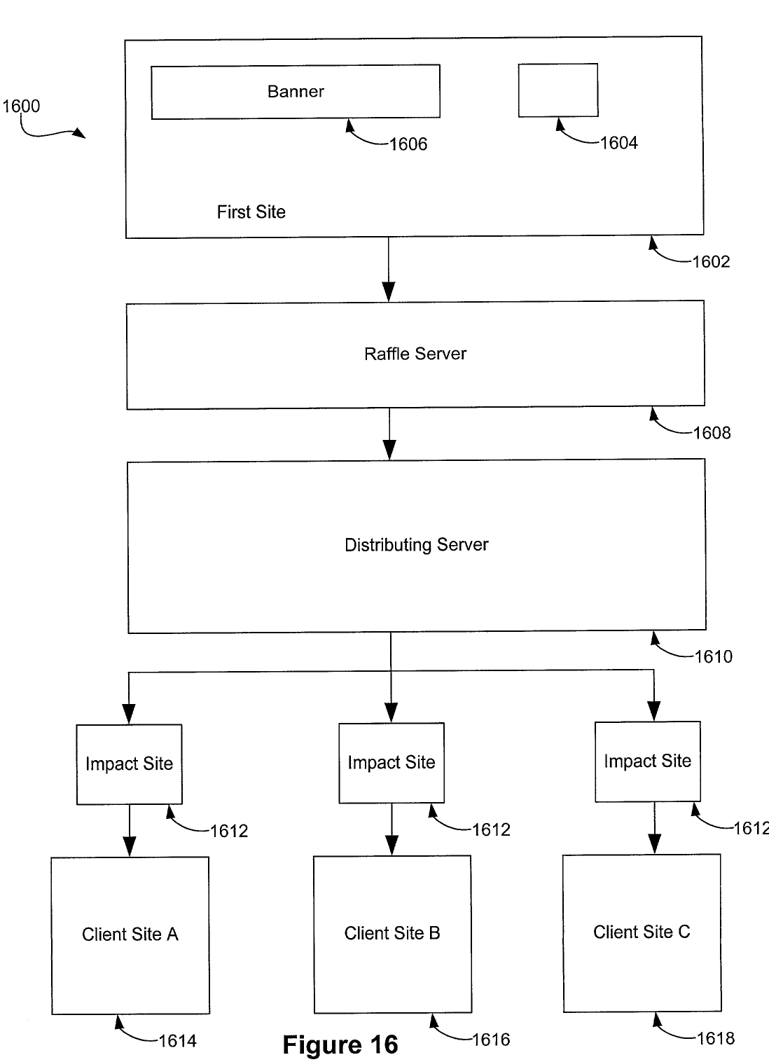

FIG. 16 is a schematic diagram illustrating a sixth configuration 1600 of the present invention for generating revenue utilizing a network in accordance with an embodiment of the present invention. In this configuration 1600, a first site 1602 contains an icon 1606, separate from a banner 1606. When the icon 1604 is selected, the user is directed to the raffle server 1608 and is offered a chance to participate in a raffle. After deciding to participate in the raffle or not, the user is directed to the distributing server 1610. The user is then prompted for information pertaining to the user. This information determines which of the impact pages 1612 to direct the user to. After the user is done viewing one of the impact pages 1612 which they were directed to, they are then linked to the corresponding client site—client site A 1614, client site B 1616 or client site C 1616. It will be appreciated by one skilled in the art that the distributing server can direct network traffic to any number of impact/client site combinations and the above example is not meant to limit the scope of the present invention.

The main difference between the fifth and sixth embodiments is the presence of the raffle server 1608. In this embodiment, more traffic to a site can be generated with this addition since it will entice users to visit the site due to the possibility of winning a prize via the raffle.

In general, banner advertisements may include text and still or moving graphics, and typically serves as an HTML link, such that the user is linked to another specified page if the user clicks on the banner. Some Internet sites are always associated with the same particular one or more banner ads; each time the site is accessed, the particular ad or ads are displayed along with the other information that is displayed (an access to a site or page is referred to as a “hit”).

In an illustration of an exemplary embodiment for displaying banner advertisements, an exemplary network architecture may comprise at least one affiliate web site, an advertisement server web site and one or more individual advertiser's web sites. Affiliates are one or more entities that generally for a fee contract with the entity providing the advertisement server permit third party advertisements to be displayed on their web sites. When a user using a browser accesses or “visits” a web site of an affiliate, an advertisement provided by the advertisement server may be superimposed on the display of the affiliate's web page displayed by the user's browser. Illustrative examples of affiliates may include: locator services, service providers, and entities that have popular web sites such as museums, and movie studios for instance.

The basic operation of such a system is as follows: when a user browsing on the Internet accesses an affiliate's web site, the user's browser generates an HTTP message to get the information for the desired web page. In response to the message, the affiliate's web site may transmit one or more messages back containing the information to be displayed by the user's browser. In addition, an advertising server process may provide additional information comprising one or more objects such as banner advertisements to be displayed with the information provided from the affiliate web site. In one possible embodiment, the computers supporting the browser, the affiliate web site and the advertising server process may be at entirely different nodes on the Internet. Upon clicking through or otherwise selecting the advertisement object, which may be an image such as an advertisement banner, an icon, or a video or an audio clip, the browser ends up being connected to the advertiser's server or web site 18 for that advertisement object.

In execution, a user may operate a web browser, such as Netscape or Microsoft Internet Explorer, on a computer or PDA or other Internet capable device to generate through the hypertext transfer protocol (HTTP) a request to one or more affiliate web sites. The affiliate web site then sends one or more messages back using the same protocol. In one embodiment, those messages may contain information available at the particular web site for the requested page to be displayed by the user's browser except for one or more advertising objects such as banner advertisements. In such an embodiment, these objects may not reside on the affiliate's web server. Instead, the affiliate's web server sends back a link including an IP address for a node running an advertiser server process as well as information about the page on which the advertisement will be displayed. The link by way of example may be a hypertext markup language (HTML) tag, referring to, for example, an inline image such as a banner. The user's browser may then transmit a message using the received IP address to access such an object indicated by the HTML tag from the advertisement server. Each message to the advertising server may include (i) the user's IP address, (ii) a cookie if the browser is cookie enabled and stores cookie information, (iii) a sub-string key indicating the page in which the advertisement to be provided from the server is to be embedded, and (iv) MIME header information indicating the browser type and version, the operating system of the computer on which the browser is operating and the proxy server type. Upon receiving the request in the message, the advertising server process may determine which advertisement or other object to provide to user's browser and then transmit the messages containing the object such as a banner advertisement to the user's browser using the HTTP protocol. In one aspect, a unique identifier for the advertiser's web page appropriate for the advertisement may be contained in the HTTP message. That advertisement object is then displayed on the image created by the web user's browser as a composite of the received affiliate's web page plus the object transmitted back by the advertising web server.

As part of the “click through” process, when the user clicks on the banner or other advertising object displayed by the user's browser, the user's browser again may transmit a message to the ad server. The ad server notes the address of the computer of the browser (or any other identifier such as a cookie or a digital signature) that generated the message and transmits back the URL of the advertiser's web page so that the user's web browser generates a message to contact the advertiser's web site. The ad server process may also note that a “click through” for an advertisement has occurred and updates the various databases in the manner described below. In such a scenario for the click through process, the ad server process may need to remember which advertisement was sent to the user's browser in order to know where to redirect the user's browser.

While various embodiments have been described above, it should be understood that they have been presented by way of example only, and not limitation. Thus, the breadth and scope of a preferred embodiment should not be limited by any of the above described exemplary embodiments, but should be defined only in accordance with the following claims and their equivalents.

What is claimed is:

1. A method for generating revenue utilizing a network comprising:
displaying indicia on a computer terminal utilizing a network;
receiving an indication upon the selection of the indicia by a user at the computer terminal utilizing the network;
prompting the entry of information relating to the user utilizing the network upon the receipt of the indication;
receiving the information relating to the user;
storing the information relating to the user in a database; and
executing a raffle function utilizing the information stored in the database.

2. A method as recited in claim 1, wherein the indicia includes a banner.

3. A method as recited in claim 1, wherein the indicia includes an icon on a banner.

4. A method as recited in claim 1, wherein the indicia is displayed in response to the selection of a banner displayed on a separate site on the network.

5. A method as recited in claim 1, wherein the entry of information is prompted on a page on the network separate from that on which the indicia is located.

6. A method as recited in claim 1, wherein the indicia includes a first indicia and a second indicia and the indication is received upon the selection of the first indicia, and further comprising linking to a separate site on the network upon the selection of the second indicia.

7. A method as recited in claim 6, wherein the second indicia is advertisement indicia.

8. A method as recited in claim 6, and further comprising linking to the separate site on the network after receiving the information relating to the user.

9. A method as recited in claim 8, wherein the separate site on the network is linked to upon the selection of a link indicia.

10. A method as recited in claim 1, wherein the indicia is displayed in response to the selection of a banner displayed from a site on the network from which the indicia is displayed.

11. A computer program embodied on a computer readable medium for generating revenue utilizing a network comprising:
a code segment that displays indicia on a computer terminal utilizing a network;
a code segment that receives an indication upon the selection of the indicia by a user at the computer terminal utilizing the network;
a code segment that prompts the entry of information relating to the user utilizing the network upon the receipt of the indication;
a code segment that receives the information relating to the user;
a code segment that stores the information relating to the user in a database; and
a code segment that executes a raffle function utilizing the information stored in the database.

12. A computer program as recited in claim 11, wherein the indicia includes a banner.

13. A computer program as recited in claim 11, wherein the indicia includes an icon on a banner.

14. A computer program as recited in claim 11, wherein the indicia is displayed in response to the selection of a banner displayed on a separate site on the network.

15. A computer program as recited in claim 11, wherein the entry of information is prompted on a page on the network separate from that on which the indicia is located.

16. A computer program as recited in claim 11, wherein the indicia includes a first indicia and a second indicia and the indication is received upon the selection of the first indicia, and further comprising linking to a separate site on the network upon the selection of the second indicia.

17. A computer program as recited in claim 16, wherein the second indicia is advertisement indicia.

18. A computer program as recited in claim 16, and further comprising a code segment that links to the separate site on the network after receiving the information relating to the user.

19. A computer program as recited in claim 18, wherein the separate site on the network is linked to upon the selection of a link indicia.

20. A computer program as recited in claim 11, wherein the indicia is displayed in response to the selection of a banner displayed from a site on the network from which the indicia is displayed.

21. A system for generating revenue utilizing a network comprising:
logic that displays indicia on a computer terminal utilizing a network;
logic that receives an indication upon the selection of the indicia by a user at the computer terminal utilizing the network;
logic that prompts the entry of information relating to the user utilizing the network upon the receipt of the indication;
logic that receives the information relating to the user;
logic that stores the information relating to the user in a database; and
logic that executes a raffle function utilizing the information stored in the database.

22. A system as recited in claim 21, wherein the indicia includes a banner.

23. A system as recited in claim 21, wherein the indicia includes an icon on a banner.

24. A system as recited in claim 21, wherein the indicia is displayed in response to the selection of a banner displayed on a separate site on the network.

25. A system as recited in claim 21, wherein the entry of information is prompted on a page on the network separate from that on which the indicia is located.

26. A system as recited in claim 21, wherein the indicia includes a first indicia and a second indicia and the indication is received upon the selection of the first indicia, and further comprising linking to a separate site on the network upon the selection of the second indicia.

27. A system as recited in claim 26, wherein the second indicia is advertisement indicia.

28. A system as recited in claim 26, and further comprising logic that links to the separate site on the network after receiving the information relating to the user.

29. A system as recited in claim 28, wherein the separate site on the network is linked to upon the selection of a link indicia.

30. A system as recited in claim 21, wherein the indicia is displayed in response to the selection of a banner displayed from a site on the network from which the indicia is displayed.

31. A method for generating revenue utilizing a network comprising:
displaying first indicia and second indicia at a first page of a first site utilizing a network, the first indicia and second indicia being displayed in response to the selection of a banner displayed on a second site on the network;
receiving an indication at the first site on the network upon the selection of either the first indicia or the second indicia by a user at a computer terminal coupled to the first site utilizing the network;
prompting the entry of information relating to the user at a second page of the first site upon the receipt of the indication that the first indicia is selected, the information relating to the user being received and stored in a database for executing a function;
displaying link indicia at the second page of the first site utilizing the network upon the receipt of the indication that the first indicia is selected, the link indicia adapted for linking to a third site on the network; and
linking to the third site on the network upon the receipt of the indication that the second indicia is selected.

32. A method as recited in claim 32, wherein the first indicia includes raffle indicia, and the function is a raffle function.

33. A computer program embodied on a computer readable medium for generating revenue utilizing a network comprising:
a code segment that displays first indicia and second indicia at a first page of a first site utilizing a network, the first indicia and second indicia being displayed in response to the selection of a banner displayed on a second site on the network;
a code segment that receives an indication at the first site on the network upon the selection of either the first indicia or the second indicia by a user at a computer terminal coupled to the first site utilizing the network;
a code segment that prompts the entry of information relating to the user at a second page of the first site upon the receipt of the indication that the first indicia is selected, the information relating to the user being received and stored in a database for executing a function;
a code segment that displays link indicia at the second page of the first site utilizing the network upon the receipt of the indication that the first indicia is selected, the link indicia adapted for linking to a third site on the network; and
a code segment that links to the third site on the network upon the receipt of the indication that the second indicia is selected.

34. A computer program as recited in claim 33, wherein the first indicia includes raffle indicia, and the function is a raffle function.

35. A system for generating revenue utilizing a network comprising:
logic that displays first indicia and second indicia at a first page of a first site utilizing a network, the first indicia and second indicia being displayed in response to the selection of a banner displayed on a second site on the network;
logic that receives an indication at the first site on the network upon the selection of either the first indicia or the second indicia by a user at a computer terminal coupled to the first site utilizing the network;
logic that prompts the entry of information relating to the user at a second page of the first site upon the receipt of the indication that the first indicia is selected, the information relating to the user being received and stored in a database for executing a function;
logic that displays link indicia at the second page of the first site utilizing the network upon the receipt of the indication that the first indicia is selected, the link indicia adapted for linking to a third site on the network; and
logic that links to the third site on the network upon the receipt of the indication that the second indicia is selected.

36. A system as recited in claim 35, wherein the first indicia includes raffle indicia, and the function is a raffle function.

37. A method for generating revenue utilizing a network comprising:
displaying first indicia and second indicia at a first page of a first site utilizing a network, the first indicia and second indicia being displayed in response to the selection of a banner displayed on a second page of the first site;
receiving an indication at the first site on the network upon the selection of either the first indicia or the second indicia by a user at a computer terminal coupled to the first site utilizing the network;
prompting the entry of information relating to the user at a third page of the first site upon the receipt of the indication that the first indicia is selected, the information relating to the user being received and stored in a database for executing a function;
displaying link indicia at the third page of the first site utilizing the network upon the receipt of the indication that the first indicia is selected, the link indicia adapted for linking to a second site on the network; and
linking to the third site on the network upon the receipt of the indication that the second indicia is selected.

38. A method as recited in claim 37, wherein the first indicia includes raffle indicia, and the function is a raffle function.

39. A computer program embodied on a computer readable medium for generating revenue utilizing a network comprising:
a code segment that displays first indicia and second indicia at a first page of a first site utilizing a network, the first indicia and second indicia being displayed in response to the selection of a banner displayed on a second page of the first site;
a code segment that receives an indication at the first site on the network upon the selection of either the first indicia or the second indicia by a user at a computer terminal coupled to the first site utilizing the network;
a code segment that prompts the entry of information relating to the user at a third page of the first site upon the receipt of the indication that the first indicia is selected, the information relating to the user being received and stored in a database for executing a function;
a code segment that displays link indicia at the third page of the first site utilizing the network upon the receipt of the indication that the first indicia is selected, the link indicia adapted for linking to a second site on the network; and
a code segment that links to the third site on the network upon the receipt of the indication that the second indicia is selected.

40. A computer program as recited in claim 39, wherein the first indicia includes raffle indicia, and the function is a raffle function.

41. A system for generating revenue utilizing a network comprising:
logic that displays first indicia and second indicia at a first page of a first site utilizing a network, the first indicia and second indicia being displayed in response to the selection of a banner displayed on a second page of the first site;
logic that receives an indication at the first site on the network upon the selection of either the first indicia or the second indicia by a user at a computer terminal coupled to the first site utilizing the network;
logic that prompts the entry of information relating to the user at a third page of the first site upon the receipt of the indication that the first indicia is selected, the information relating to the user being received and stored in a database for executing a function;
logic that displays link indicia at the third page of the first site utilizing the network upon the receipt of the indication that the first indicia is selected, the link indicia adapted for linking to a second site on the network; and
logic that links to the third site on the network upon the receipt of the indication that the second indicia is selected.

42. A system as recited in claim 41, wherein the first indicia includes raffle indicia, and the function is a raffle function.

43. A method for generating revenue utilizing a network comprising:
displaying first indicia and second indicia at a first page of a first site utilizing a network, the first indicia and second indicia being displayed in response to the selection of a banner displayed on one or more preceding sites;
receiving an indication at the first site on the network upon the selection of either the first indicia or the second indicia by a user at a computer terminal coupled to the first site utilizing the network;
prompting the entry of information relating to the user at a second page of the first site upon the receipt of the indication that the first indicia is selected, the information relating to the user being received and stored in a database for executing a function;
displaying link indicia at the second page of the first site utilizing the network upon the receipt of the indication that the first indicia is selected, the link indicia adapted for linking to a third page of the second site on the network; and
linking to the third page of the second site on the network upon the receipt of the indication that the second indicia is selected.

44. A method as recited in claim 43, wherein the first indicia includes raffle indicia, and the function is a raffle function.

45. A computer program embodied on a computer readable medium for generating revenue utilizing a network comprising:
a code segment that displays first indicia and second indicia at a first page of a first site utilizing a network, the first indicia and second indicia being displayed in response to the selection of a banner displayed on one or more preceding sites;
a code segment that receives an indication at the first site on the network upon the selection of either the first indicia or the second indicia by a user at a computer terminal coupled to the first site utilizing the network;
a code segment that prompts the entry of information relating to the user at a second page of the first site upon the receipt of the indication that the first indicia is selected, the information relating to the user being received and stored in a database for executing a function;
a code segment that displays link indicia at the second page of the first site utilizing the network upon the receipt of the indication that the first indicia is selected, the link indicia adapted for linking to a third page of the second site on the network; and
a code segment that links to the third page of the second site on the network upon the receipt of the indication that the second indicia is selected.

46. A computer program as recited in claim 45, wherein the first indicia includes raffle indicia, and the function is a raffle function.

47. A system for generating revenue utilizing a network comprising:
logic that displays first indicia and second indicia at a first page of a first site utilizing a network, the first indicia and second indicia being displayed in response to the selection of a banner displayed on one or more preceding sites;
logic that receives an indication at the first site on the network upon the selection of either the first indicia or the second indicia by a user at a computer terminal coupled to the first site utilizing the network;
logic that prompts the entry of information relating to the user at a second page of the first site upon the receipt of the indication that the first indicia is selected, the information relating to the user being received and stored in a database for executing a function;
logic that displays link indicia at the second page of the first site utilizing the network upon the receipt of the indication that the first indicia is selected, the link indicia adapted for linking to a third page of the second site on the network; and
logic that links to the third page of the second site on the network upon the receipt of the indication that the second indicia is selected.

48. A system as recited in claim 47, wherein the first indicia includes raffle indicia, and the function is a raffle function.

49. A method for generating revenue utilizing a network comprising:
displaying a first indicia and a second indicia on a computer terminal from a first site utilizing a network, the first indicia and second indicia being displayed in response to the selection of a banner displayed on a second site on the network;
receiving an indication upon the selection of either the first indicia or the second indicia by a user at the computer terminal utilizing the network;
prompting the entry of information relating to the user at the first site upon the receipt of the indication that the first indicia is selected, the information relating to the user being received and stored in a database for executing a function; and
linking to a third site associated with the second indicia upon receipt of the indication that the second indicia is selected.

50. A method as recited in claim 49, wherein the function is a raffle function.

51. A computer program embodied on a computer readable medium for generating revenue utilizing a network comprising:
a code segment that displays a first indicia and a second indicia on a computer terminal from a first site utilizing a network, the first indicia and second indicia being displayed in response to the selection of a banner displayed on a second site on the network;
a code segment that receives an indication upon the selection of either the first indicia or the second indicia by a user at the computer terminal utilizing the network;
a code segment that prompts the entry of information relating to the user at the first site upon the receipt of the indication that the first indicia is selected, the information relating to the user being received and stored in a database for executing a function; and
a code segment that links to a third site associated with the second indicia upon receipt of the indication that the second indicia is selected.

52. A computer program as recited in claim 51, wherein the function is a raffle function.

53. A system for generating revenue utilizing a network comprising:
logic that displays a first indicia and a second indicia on a computer terminal from a first site utilizing a network, the first indicia and second indicia being displayed in response to the selection of a banner displayed on a second site on the network;
logic that receives an indication upon the selection of either the first indicia or the second indicia by a user at the computer terminal utilizing the network;
logic that prompts the entry of information relating to the user at the first site upon the receipt of the indication that the first indicia is selected, the information relating to the user being received and stored in a database for executing a function; and
logic that links to a third site associated with the second indicia upon receipt of the indication that the second indicia is selected.

54. A system as recited in claim 53, wherein the function is a raffle function.

55. A method for generating revenue utilizing a network comprising:
displaying an indicia separate from a banner on a computer terminal from a first site utilizing a network;
receiving an indication upon the selection of the indicia separate from the banner by a user at the computer terminal utilizing the network;
linking to a distributing server upon receipt of the indication that the indicia is selected; and
linking to one of several client sites by the distributing server.

56. A computer program embodied on a computer readable medium for generating revenue utilizing a network comprising:
a code segment that displays an indicia separate from a banner on a computer terminal from a first site utilizing a network;
a code segment that receives an indication upon the selection of the indicia separate from the banner by a user at the computer terminal utilizing the network;
a code segment that links to a distributing server upon receipt of the indication that the indicia is selected; and
a code segment that links to one of several client sites by the distributing server.

57. A system for generating revenue utilizing a network comprising:
logic that displays an indicia separate from a banner on a computer terminal from a first site utilizing a network;
logic that receives an indication upon the selection of the indicia separate from the banner by a user at the computer terminal utilizing the network;
logic that links to a distributing server upon receipt of the indication that the indicia is selected; and
logic that links to one of several client sites by the distributing server.

58. A method for generating revenue utilizing a network comprising:
displaying an indicia separate from a banner on a computer terminal from a first site utilizing a network;
receiving an indication upon the selection of the indicia separate from the banner by a user at the computer terminal utilizing the network;
linking to a distributing server upon receipt of the indication that the indicia is selected;
prompting the entry of information relating to the user at the distribution serve;
linking to one of several impact sites by the distributing server based upon the information submitted by the user; and
linking to a client site after the user is done viewing the impact site.

59. A computer program embodied on a computer readable medium for generating revenue utilizing a network comprising:
a code segment that displays an indicia separate from a banner on a computer terminal from a first site utilizing a network;
a code segment that receives an indication upon the selection of the indicia separate from the banner by a user at the computer terminal utilizing the network;
a code segment that links to a distributing server upon receipt of the indication that the indicia is selected;
a code segment that prompts the entry of information relating to the user at the distribution serve;
a code segment that links to one of several impact sites by the distributing server based upon the information submitted by the user; and
a code segment that links to a client site after the user is done viewing the impact site.

60. A system for generating revenue utilizing a network comprising:
logic that displays an indicia separate from a banner on a computer terminal from a first site utilizing a network;
logic that receives an indication upon the selection of the indicia separate from the banner by a user at the computer terminal utilizing the network;
logic that links to a distributing server upon receipt of the indication that the indicia is selected;
logic that prompts the entry of information relating to the user at the distribution serve;
logic that links to one of several impact sites by the distributing server based upon the information submitted by the user; and
logic that links to a client site after the user is done viewing the impact site.

61. A method for generating revenue utilizing a network comprising:
displaying an indicia separate from a banner on a computer terminal from a first site utilizing a network;
receiving an indication upon the selection of the indicia separate from the banner by a user at the computer terminal utilizing the network;
linking to a raffle server upon receipt of the indication that the indicia is selected;
linking to a distributing server upon receipt of the indication that the user did or did not participate in a raffle;
prompting the entry of information relating to the user at the distribution serve;
linking to one of several impact sites by the distributing server based upon the information submitted by the user; and
linking to a client site after the user is done viewing the impact site.

62. A computer program embodied on a computer readable medium for generating revenue utilizing a network comprising:
a code segment that displays an indicia separate from a banner on a computer terminal from a first site utilizing a network;
a code segment that receives an indication upon the selection of the indicia separate from the banner by a user at the computer terminal utilizing the network;
a code segment that links to a raffle server upon receipt of the indication that the indicia is selected;
a code segment that links to a distributing server upon receipt of the indication that the user did or did not participate in a raffle;
a code segment that prompts the entry of information relating to the user at the distribution serve;
a code segment that links to one of several impact sites by the distributing server based upon the information submitted by the user; and
a code segment that links to a client site after the user is done viewing the impact site.

63. A system for generating revenue utilizing a network comprising:
logic that displays an indicia separate from a banner on a computer terminal from a first site utilizing a network;
logic that receives an indication upon the selection of the indicia separate from the banner by a user at the computer terminal utilizing the network;
logic that links to a raffle server upon receipt of the indication that the indicia is selected;
logic that links to a distributing server upon receipt of the indication that the user did or did not participate in a raffle;
logic that prompts the entry of information relating to the user at the distribution serve;
logic that links to one of several impact sites by the distributing server based upon the information submitted by the user; and
logic that links to a client site after the user is done viewing the impact site.
